(19) United States
(12) Patent Application Publication
(10) Pub. No.: US 2008/0071687 A1
(43) Pub. Date: Mar. 20, 2008

(54) DIRECT RESPONSE SYSTEM FOR AND METHOD OF SELLING PRODUCTS

(76) Inventor: Charles Hengel, Woodland, MN (US)

Correspondence Address: SCHWEGMAN, LUNDBERG & WOESSNER, P.A., P.O. BOX 2938, MINNEAPOLIS, MN, 55402, US

(21) Appl. No.: 11/469,731

(22) Filed: Sep. 1, 2006

(51) Int. Cl. H04L 9/00; H04M 3/00

(52) U.S. Cl. 705/52; 379/265.11

(57) ABSTRACT

This document describes, among other things, systems and methods for selling products using direct response. A system comprises a call routing system and a website server system; the website server system adapted to provide a listing of products or services to a user through a portal website and further adapted to receive an indication from the user and use the indication to determine relevant products or services to list using the indication, wherein the listing includes at least one phone number for the user to call with respect to at least one of the one or more relevant products or services, wherein the phone number is routed through the call routing system.

### TECHNICAL FIELD

This patent document pertains generally to systems for conducting retail transactions, and more particularly, but not by way of limitation, to a direct response system for, and method of, selling products.

### BACKGROUND

In recent years, the Internet has transformed from an auxiliary communication medium for academics and large organizations into an entrenched communication medium that spans across nearly all parts of mainstream society. One primary use of the Internet is the World Wide Web (WWW). Millions of users provide billions of documents on the WWW comprising a vast and diverse universe of information. Specialized websites, such as web portals, search engines, directories, and catalogs enable online users to search and traverse the WWW universe. Most search engines find information using one or more keywords provided by a user. Some search engines specialize in a subject area or type of file. Others, called meta-search engines, query a number of regular search engines and collect the best results.

Frequently, after a user performs a web search, the immense number of websites and documents that match the search overwhelm the user. The user is then required to wade through enormous amounts of data to find the most relevant link. Many users may refuse to perform this arduous task. The difficulty of the task is compounded when the user is searching for a high-quality or reputable product or service. Finding relevant websites is only the first step; the user must then evaluate a number of relevant websites to determine the most affordable, reliable, or available product or service.

Sellers of products and services face similar problems. Websites are easily lost amongst a sea of data, and even with targeted advertising campaigns, it is difficult to convert a browsing user on a website into a sale. Sellers can spend millions of dollars each year in developing and promoting their web presence where sales success online has been the exception, rather than the norm. Some sellers use direct response marketing, which typically has better sales conversion rates than general advertising. As an example, businesses generally have a much higher closing rate when a potential customer can talk with a live service agent over the phone as opposed to browsing a business' website for information or purchase.

### BRIEF DESCRIPTION OF THE DRAWINGS

FIG. 1 illustrates a functional block diagram of a direct response system in accordance with an example embodiment.

FIG. 2 illustrates a flow diagram of a method of operating direct response system in accordance with an example embodiment.

FIG. 3 illustrates a flow diagram of a method of the development for a direct response system in accordance with an example embodiment.

FIG. 4 is a chart illustrating a scoring mechanism in accordance with an example embodiment.

FIG. 5 illustrates a flow diagram of an example of an invoicing process in accordance with an example embodiment

FIG. 6 illustrates a flow diagram of a method for using a direct response system in accordance with an example embodiment.

FIG. 7 illustrates a flow diagram of a method of processing a call in a direct response system in accordance with an example embodiment.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

The present invention includes a system for conducting retail transactions. In particular, a direct response system receives and organizes participating sellers, provides multimedia advertisements of each participating seller, ranks each participating seller, and routes incoming calls from interested potential buyers to the corresponding seller's call center.

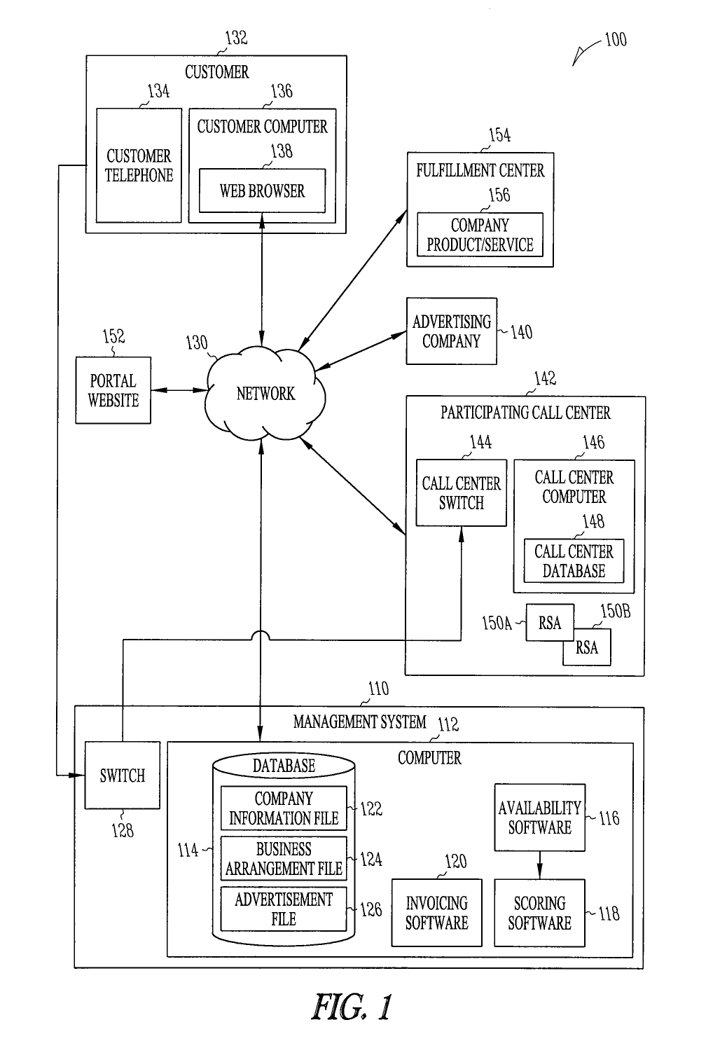

FIG. 1 illustrates a functional block diagram of a direct response system 100 in accordance with an example embodiment. Direct response system 100 includes a management system 110, which includes a computer 112 and a switch 128. Computer 112 further includes a database 114, an availability software 116, a scoring software 118, and an invoicing software 120. Database 114 further includes a company information file 122, a business arrangement file 124, and an advertisement file 126. Direct response system 100 further includes a network 130, a customer 132, who has a customer telephone 134 and a customer computer 136 with a web browser 138, an advertising company 140, a participating call center 142, a portal website 152, a fulfillment center 154, and a company product/service 156. Participating call center 142 further includes a call center switch 144, a call center computer 146, which includes a call center database 148, and one or more remote service agents (RSA) 150, for example, remote service agents 150a and 150b.

In an embodiment, management system 110 includes any person or system responsible for the administration of computers, networks, or software systems within direct response system 100. In an embodiment, computer 112 includes a networked computer server used to store and distribute information relevant to specific companies. Computer 112 may contain components including databases, such as database 114, and software, such as availability software 116, scoring software 118, and invoicing software 120.

In an embodiment, database 114 includes a commercial database system, such as those available from Oracle, Microsoft, or IBM. Database 114 may be a relational database and contain a collection of related data. More particularly, database 114 includes company information file 122, business arrangement file 124, and advertisement file 126.

In an embodiment, company information file 122 includes pertinent background information related to a specific company. Business arrangement file 124 includes one or more business arrangements between company product/service 156 and management system 110. Advertisement file 126 includes advertising information, such as textual and graphical content for an online advertisement of the products or services of a company within company information file 122. In one embodiment, advertisement file 126 contains a short text description of the product or service being advertised and a toll-free number to present to the customer for them to call for more information or to order the product. In embodiments, advertisement file 126 does not include data or links to an advertiser's online catalog or order form. In such an embodiment, it is perceived to be advantageous to direct a potential customer to a live operator instead of an online catalog or order form. In particular, phone calls are generally more effective at closing sales than providing an online ordering system, so much so that it may be preferable to direct potential customers to a live phone representative than to an informational website.

In an embodiment, availability software 116 includes a software program that interfaces with various call centers that sell a specific product or service. Availability software 116 may periodically or regularly connect with the call centers or may be continuously connected to the call center to perform queries and updates at or near real-time. Availability software 116 can determine the availability of call center agents. As needed, availability software 116 queries participating call centers 142 via network 130 to determine one or more metrics, such as the average speed that a call is answered at a call center (e.g., the average hold time), the number of working agents, or the like.

In an embodiment, scoring software 118 includes a software program that categorizes and ranks companies that are selling a company product/service 156. Scoring software 118 can use one or more criteria including the availability of agents in call centers, the product's or service's price, customer satisfaction rankings of the product or service, or industry awards or recognition. For example, in an embodiment, rankings within scoring software 118 are based partly on an established scoring system, such as product rankings from Consumer Reports. Scoring software 118 can analyze companies within company information file 122 and calculate their respective ranks or positions.

In an embodiment, invoicing software 120 includes a software program that allows computer 112 to invoice advertising company 140 for calls referred to participating call center 142.

In an embodiment, switch 128 includes a telecommunications network device that selects a path or circuit for sending a unit of data to its next destination. Switch 128 may also include the function of a router, which determines a route to a network destination point. Switch 128 may include, in various embodiments, conventional telecommunications switch functionality, such as interactive voice response (IVR), call recording functionality, and the like. Network 130 includes a communications or data network, such as a local area network (LAN), wide area network (WAN), or the Internet.

Customer 132 includes a person or company that searches portal website 152 in order to find information on a particular product or service. Customer telephone 134 is a telecommunications device, such as a mobile phone or a standard land-line telephone, which transmits and receives voice data. Customer computer 136 includes a laptop, desktop, or networked computer. Customer computer 136 further includes components, such as web browser 138. Web browser 138 includes a software program that provides a graphical interface that allows users to view and navigate web pages.

Advertising company 140 includes a company or business that advertises or places content on direct response system 100 via a business arrangement with management system 110.

Participating call center 142 includes a call center that handles inbound calls. For example, participating call center 142 is the call center for a specific company, such as advertising company 140. Participating call center 142 may include a sophisticated voice operations center that provides a full range of high-volume, inbound call-handling services, for example, customer support, operator services, or directory assistance. Associated with each participating call center 142 are one or more remote service agents (RSA) 150. RSA 150 may include people who are trained and knowledgeable in one or more product or service areas for a specific company.

Each participating call center 142 maintains one or more call center computers 146. Call center computer 146 includes a networked computer server used to store and distribute information. Call center computer 146 also includes call center database 148. In various embodiments, call center database 148 includes a commercial database system, such as those available from Oracle, Microsoft, or IBM. Call center database 146 may be a relational database and contain a collection of related data. Call center database 148 stores data received from customers by RSA 150. Call center database 148 may also include data derived from customer calls. For example, call center database 148 may contain the number of calls transferred, the number of calls converted into sales, order data, customer information collected by RSA 150, or the like. Participating call center 142 also includes call center switch 144, which is a telecommunications network device that selects a path or circuit for sending data to its next destination, such as a sales agent or group of sales agents. In some embodiments, call center switch 144 stores generic call data, such as the number of calls received, which agent the call was routed to, the length of call, and the like. In an embodiment, calls routed from switch 128 are handled by call center switch 144.

In an embodiment, portal website 152 includes a website that provides a user interface that allows customers to search or browse for products or services. Portal website 152 may be provided by one or more servers, collectively termed a website server system, which may include a web server, a database server, an application server, a file server, or other servers to enable and provide an interactive website. Alternatively, portal website 152 is located on one or more servers within management system 110.

In an example embodiment, during operation, management system 110 selects products or services to participate. One or more companies within an industry are evaluated by management system 110, such as by an established scoring system. The evaluations are stored in company information file 122 by scoring software 118. Formalized business agreements are made between management system 110 and the selected companies. The formalized business agreements are stored in business arrangement file 124. Creative content is developed, such as by advertising company 140, management system 110, or a third party, and a phone number, such as a unique toll-free number, is created to include with each participating company's advertisement. The phone number may be assigned and managed by management system 110. Portal website 152 may be developed by management system 110. The creative content and unique toll-free number are uploaded to advertisement file 126 and stored in database 114 of computer 112.

Customer 132 can use web browser 138 to access portal website 152 and search for a product or service. Scoring software 118 utilizes availability software 116 and reviews one or more company information files 122 to determine company advertisements that are relevant to customer's search. Advertisements are retrieved from advertisement file 126 and may contain a phone number for customer 132 to call. The advertisements are presented using a ranking derived from scoring software 118. Using customer phone 134, customer 132 can select a company from the list and call the phone number. The call is routed through switch 128 to call center switch 144. Call center switch 144 routes the call to RSA 150.

Customer 132 can speak with RSA 150 at participating call center 142. RSA 150 may answer questions from customer 132 regarding a specific product or service or assist in expanding customer's knowledge base of the product or service. Also, RSA 150 may attempt to sell customer 132 the specific product or service.

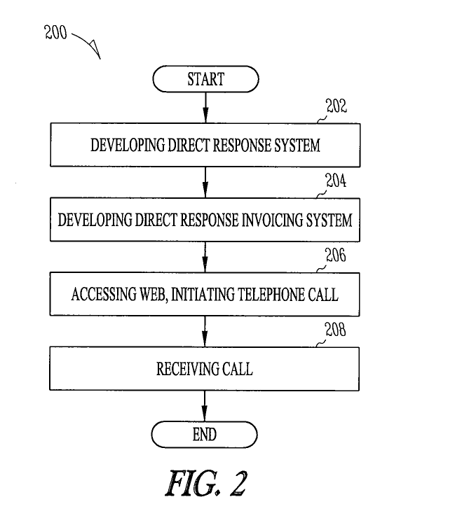

FIG. 2 illustrates a flow diagram of a method 200 of operating direct response system 100 in accordance with an example embodiment. Method 200 is a high-level method that describes one example embodiment of the overall operation of direct response system 100.

At 202, management system 110 develops a direct response system 100. In an embodiment, development of direct response system 100 includes selecting one or more companies or industries to participate as advertisers. Participation may be based on one or more criteria, such as whether the company is approved by the Better Business Bureau (BBB), whether the company provides a credit refund or has a credit refund policy, whether the company pre-screens credit cards to reduce fraud, or other quality or customer service indicia such as reviews, awards, or the like. Factors such as these may be weighted or scaled to prefer product quality, customer service, price, or other product or service characteristics.

At 204, management system 110 develops one or more invoicing processes for direct response system 100. In an embodiment, invoice process development includes developing business arrangements with participating advertising companies 140, receiving aggregated reports from participating call centers 142 and fulfillment centers 154, analyzing the aggregated reports, and invoicing the participating companies.

At 206, one or more customers 132 access portal website 152 to view advertising from participating advertising companies 140. Based upon these ads, the customer 132 can initiate a phone call to a company. In an embodiment, advertisements using one or more advertising mediums may be used to drive traffic to the portal website 152. Advertising mediums may include, in various embodiments, online advertising, push advertising (e.g., to a cellular phone, to a browser over a persistent Internet connection, or the like), radio advertising, television advertising, or print advertising. For example, a radio advertisement may advertise the portal website 152 generally, such as by announcing: “Would you like to know the top five service providers in your area? Visit www.top5.com and find out more.” A listener may then visit the website (e.g., www.top5.com) and search or browse to find a service or product of interest. Upon finding the product or service, the listener can call one of the providers and be connected with a live sales agent to obtain additional information.

At 208, a participating call center 142, which is associated with a company product/service 156, receives the call from customer 132. Remote service agent (RSA) 150 can speak directly with the customer 132 to handle the customer inquiry.

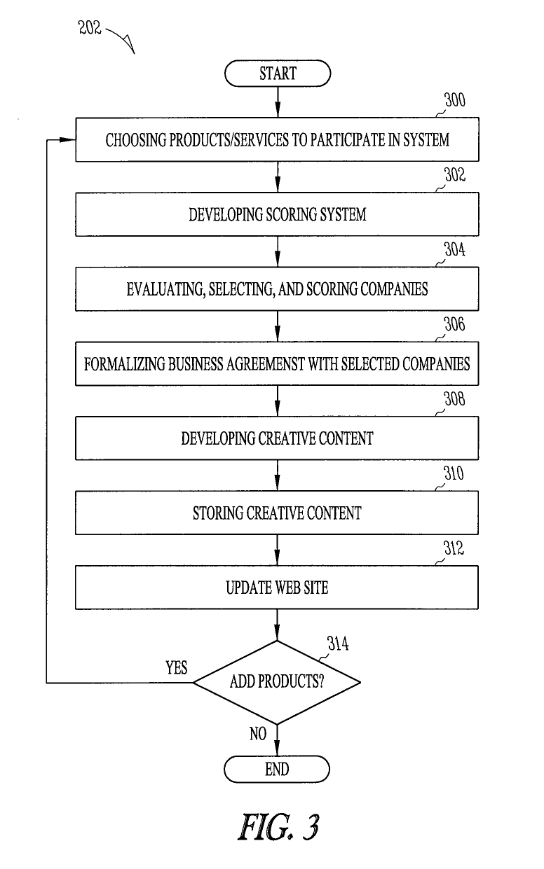

FIG. 3 illustrates a flow diagram of a method 202 of the development for a direct response system 100 in accordance with an example embodiment. At 300, one or more company product/services 156 are selected to participate in the direct response system 100. In an embodiment, products or services that have a historically strong record of sales are selected first.

At 302, a scoring system is developed. In various embodiments, one or more factors are used to determine an overall score of a product or service, such as a price, an indicia of customer satisfaction, a third-party score, an adjustment value, or an availability. An additional factor may include whether the participating company has an available advertising budget remaining. In an embodiment, participating companies can pre-pay for referrals through management system 110. After a customer 132 is referred to a participating call center 142, the participating company's account is debited by the referral fee. If a participating company's account balance is zero, then further referrals are not provided by management system 110. Another factor that may affect scoring is a geographic score. A geographic score may be determined by querying the customer 132 at portal website 152 for some indicia of the customer's location (e.g., ZIP code or state). By analyzing company information file 122 in database 114, portal website 152 may be able to determine which companies are located closer to customer 132 and adjust scores based on proximity.

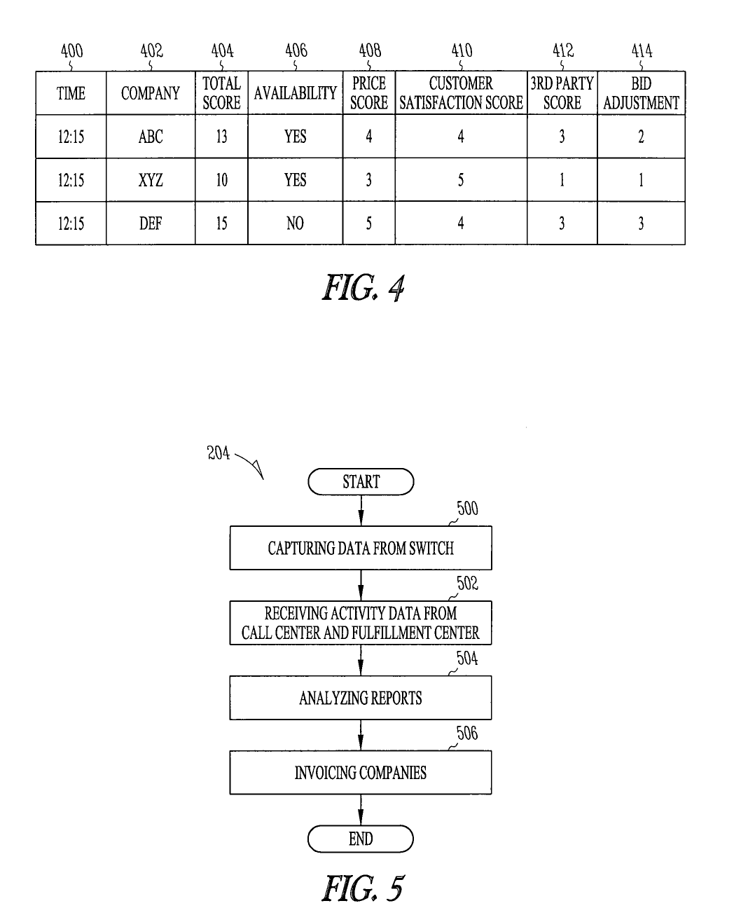

FIG. 4 is a chart illustrating a scoring mechanism in accordance with an example embodiment. The chart in this example includes a time 400, a company 402, a total score 404, an availability 406, a price score 408, a customer satisfaction score 410, a 3^{rd} party score 412, and a bid adjustment 414. The time 400 indicates the time of the customer inquiry, such as when the customer requested the list on the portal website 152. Company 402 refers to the company that provides the product or service being scored. Total score 404 is the overall score of the company using one or more factors, as described herein. In an embodiment, total score 404 is calculated by adding price score 408, customer satisfaction score 410, 3^{rd} party score 412, and bid adjustment 414. Price score 408 is an indication of a particular company's price in relation to a reference price. The reference price may be the other companies in the search results (e.g., “ABC,” “XYZ,” or “DEF”), or other price, such as a national average, a Blue Book value, or the like. In this example, a lower price will receive a higher score. Customer satisfaction score 410 may be based such things as purchasing customers' reviews or comments, customer service surveys, or other customer feedback. Customer satisfaction score 410 can be normalized and used as a factor in the total score 404. Third-party score 412 may include one or more external data sources, such as those published in Consumer Reports or other trade journals, and may be used as an additional factor in the total score 404. Bid adjustment 414 may be used to increase the total score 404. The bid adjustment 414 value may include a subjective increase or decrease in the overall score based on reputation, preference, or external information not accounted for by another factor. A participating company may compensate the provider of the portal website 152 and/or the management system 110 to raise the bid adjustment 414 value (e.g., the participating company may purchase a premium account to feature a product, service, or company). As another example, if the company agrees to provide a premium or higher level of service for customers referred through the portal website 152, (e.g., special pricing, incentive offers, increased warranty periods), then the company's bid adjustment 414 value may be adjusted upwards and effect the company's total score 404.

In the example shown in FIG. 4, three companies are provided as a result of a user's search. In other embodiments, more or fewer companies may be returned, such as to provide a “top 5”, “top 10”, or “top 20” list of relevant products or services. In FIG. 4, company “ABC” is ranked first and company “XYZ” is ranked second based on their respective total scores 404, and while company “DEF” has the highest total score 404 of the three companies, it is ranked third because at the time of the scoring, company “DEF” did not have any agents available to receive phone call inquires. In an embodiment, the availability 406 is determined at the time of the user query (e.g., when the user performs a search or navigates to a particular category of products or services) and companies that do not have available agents are listed last regardless of their total score 404. Users may be presented with some or all of the data illustrated in FIG. 4. For example, after being presented with a company's total score 404 and availability 406, a user decides to wait for company “DEF” to become available based on the high total score 404.

Referring again to FIG. 3, at 304, companies that supply a particular product or service are selected, evaluated, and scored. In an embodiment, companies within an industry are evaluated by management system 110 using a scoring system. In one embodiment, the scoring system uses an external score generated by an independent party, such as Consumer Reports or other industry trade reviews. In an embodiment, external scoring is captured by scoring software 118.

At 306, one or more business agreements are formalized. Business agreements can be made between management system 110 and one or more selected companies. Formalized business agreements may include terms, such as compensation for referrals, fees for an increased ranking, or other details about the business arrangement between management system 110 and a selected company. In an embodiment, the details of a business agreement are stored in business arrangement file 124 of database 114.

At 308, creative content is developed. In various embodiments, the creative content is developed by the participating company, management system 110, or a third party. In addition, in an embodiment, a unique toll-free number is assigned to a participating company advertisement by the management system 110.

At 310, creative content and the associated unique toll-free number are stored in the database 114. In an embodiment, the information is stored in advertisement file 126. In some embodiments, auxiliary creative content is developed, such as to support advertising campaigns with the intent of driving traffic to a portal website 152.

At 312, a portal website 152 is updated. In an embodiment, portal website 152 is developed and managed by management system 110. Management system 110 may update static web pages on portal website 152 to include the new products or services. In another embodiment, portal website 152 is implemented using dynamic web programming, such as JavaScript, Active Server Pages, or the like, such that when database 114 is updated, portal website 152 may dynamically update its contents for browsers.

Portal website 152 includes one or more navigational or search user interfaces. In an embodiment, portal website 152 includes a search user interface where a user may enter one or more key words or phrases and portal website 152 may provide search results that include one or more advertisements of relevant products or services. In another embodiment, portal website 152 includes one or more groupings or categories of products or services, which may be navigated using a menu or other hierarchal browsing.

As a result of searching or browsing, the user is presented with a listing of relevant products or services. The listing may include advertisements. In an embodiment, the advertisements include a unique phone number (e.g., a toll-free number) and text or graphical advertising copy. For example, a banner or image may be displayed next to a unique toll-free number that connects the customer to a corresponding participating call center 142 via switch 128 and call center switch 144. In an alternative embodiment, search results are presented as a list of descriptive links, which the user may select to view a more detailed advertisement that includes a phone number.

At 314, management system 110 determines whether there are more products to be added to direct response system 100. In an embodiment, the decision of whether to add more products is based on market data. For example, market data may identify a product or service that sells well via direct response methods, but which is not offered currently via direct response system 100. If market data exists that warrants the addition of more products, then the method 202 continues at block 300.

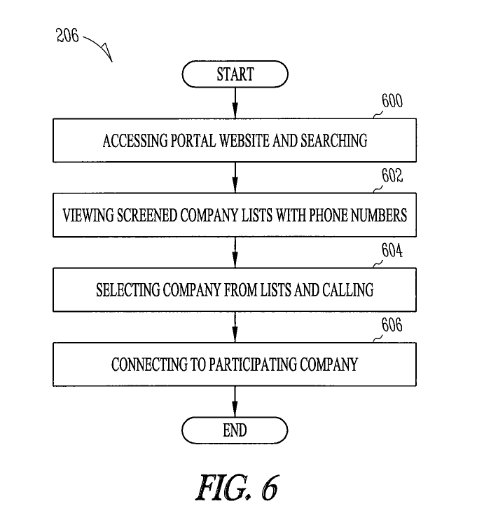

FIG. 5 illustrates a flow diagram of an example of an invoicing process in accordance with method 204 in FIG. 2. At 500, data is captured at switch 128 as calls are routed to call center switch 144. In various embodiments, data includes the number of calls referred to a participating call center 142, the phone number of the caller (e.g., caller ID information), the time and length of a call, or a recording of the call.

At 502, one or more reports are received from at least one of participating call center 142 or fulfillment center 154. In some embodiments, reports are aggregated reports and are sent via email, postal mail, fax, or the like. Reports may include information such as the number of calls received, the time of each call, the length of each call, and the number of resulting sales. Other information may be included in the reports, such as client information, shipping information, billing information, and the like. Reports may be sent on periodic or regular intervals, for example, daily, weekly, monthly, or quarterly.

At 504, the reports are analyzed. In an embodiment, management system 110 analyzes the reports received from participating call center 142 and fulfillment center 154 to verify information. For example, management system 110 may check and compare the number of calls that switch 128 reported as referred to participating call center 142 against the number of calls participating call center 142 indicates were received by call center switch 144. Any inconsistencies may be followed up by management system 110.

At 506, using the results of the analysis, one or more participating companies, which are associated with participating call center 142, are invoiced for referrals. In various embodiments, invoices are delivered via email, postal mail, fax, or the like. In an embodiment, invoices are made available to the participating companies via a website management system 110. For example, a participating company may connect with a web server at management system 110 and view a past or current invoice online.

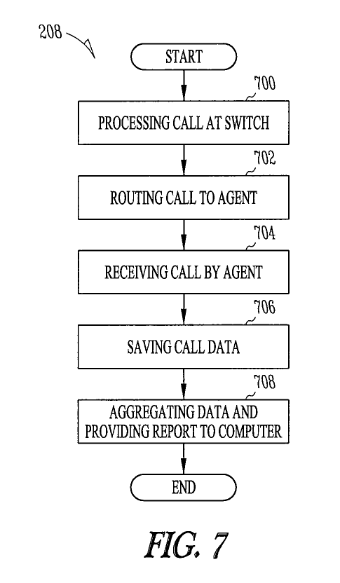

FIG. 6 illustrates a flow diagram of a method 206 for using direct response system 100 in accordance with an example embodiment. At 600, portal website 152 is accessed and searched. For example, customer 132 may use web browser 138 to browse portal website 152. Customer 132 may then search portal website 152 for a specific product or service. In one embodiment, portal website 152 is presented as a search engine similar to Google.com provided by Google of Mountain View, Calif. In an alternative embodiment, portal website 152 displays a listing of one or more reviewed products or services and the user may select one in order to view a corresponding advertisement. The listing may be organized into product or service categories to assist the user.

At 602, one or more advertisements are presented. In an embodiment, the advertisements are displayed as a result of a search performed by customer 132. In an embodiment, scoring software 118 utilizes availability software 116, one or more company information files 122, and one or more corresponding advertisement files 126 to determine relevant advertisements based on a query and rank the relevant advertisements. In embodiments, advertisements include text, graphics, or other multimedia elements. In an embodiment, advertisements include a phone number (e.g., a toll-free number) to contact the advertising company. For example, if the customer 132 uses the search terms “home refinance” at portal website 152, the top three mortgage lender advertisements based on scores derived from scoring software 118 may be displayed for customer 132 to review. In an embodiment, scores are calculated at the time of the query. Each advertisement may contain a small advertisement copy (e.g., text, graphic, animated graphic) as well as a unique toll-free number for customer 132 to call for further details.

At 604, a user contacts a selected company. In an embodiment, customer 132 may select a company based on at least one of an advertisement or ranking and call the corresponding unique toll-free number.

At 606, a user is connected with a participating company. In an embodiment, customer 132 may speak with a remote service agent (RSA) 150 at participating call center 142. The RSA 150 may answer questions as well as educate customer 132 regarding the product or service. RSA 150 may also gather customer information or attempt to sell customer 132 a product or service.

FIG. 7 illustrates a flow diagram of a method 208 of processing a call in a direct response system in accordance with an example embodiment. At 700, a call is received at switch 128. Switch 128 may capture aspects of incoming calls as described above at block 500. Switch 128 determines a corresponding participating call center 142 and routes the call to the associated call center switch 144.

At 702, the call is routed to an available agent. In an embodiment, call center switch 144 determines one or more available agents and routes the call to at least one available agent. If no agents are available, call center switch 144 may provide a voice message to the caller while the call is queued for processing.

At 704, the call is received by an available agent (e.g., RSA 150). The agent may provide answers and other information to customer 132.

At 706, call data is collected. In an embodiment, RSA 150 may collect various data during or after a call, such as personal customer data, customer billing data, order data, or the like.

At 708, call data is saved. In an embodiment, RSA 150 may save collected data to call center database 148.

At 710, one or more reports are generated. In an embodiment, periodically or regularly, participating call center 142 may manually or automatically provide collected call data. The collected call data may include aggregated data from call center database 148 or call center switch 144. Data collected from call center switch 144 may include, for example, the number of calls received, the length of each call, and the RSA 150 to whom the call was transferred. Collected data may be aggregated over a time period, for example, daily, weekly, monthly, or quarterly. At periodic or regular intervals, reports are transmitted to computer 112 for analysis and review by management system 110.

Various embodiments may provide one or more advantages, including a search website that features focused product or service vendors and a direct marketing channel that may increase the effectiveness or efficiency of a company's marketing plan.

It is to be understood that the above description is intended to be illustrative and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

For the purposes of this specification, the term “machine-readable medium” or “computer-readable medium” shall be taken to include any medium which is capable of storing or encoding a sequence of instructions for execution by the machine and that cause the machine to perform any one of the methodologies of the inventive subject matter. The terms “machine-readable medium” or “computer-readable medium” shall accordingly be taken to include, but not be limited to, solid-state memories, optical and magnetic disks, and carrier wave signals. Further, it will be appreciated that the software could be distributed across multiple machines or storage media, which may include the machine-readable medium.

Method embodiments described herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer-readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read-only memories (ROMs), and the like.

The foregoing description of specific embodiments reveals the general nature of the inventive subject matter sufficiently that others can, by applying current knowledge, readily modify and/or adapt it for various applications without departing from the generic concept. Therefore, such adaptations and modifications are within the meaning and range of equivalents of the disclosed embodiments. The phraseology or terminology employed herein is for the purpose of description and not of limitation. Accordingly, the inventive subject matter embraces all such alternatives, modifications, equivalents and variations as fall within the spirit and broad scope of the appended claims.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

1. A system comprising:
at least one call routing system and at least one website server system;
the website server system adapted to provide a listing of one or more products or services to a user through a portal website, wherein the server system is adapted to receive an indication from the user through the portal website and use the indication to determine the one or more relevant products or services to list using the indication, and further wherein the relevant products or services are listed in at least one ranked order, wherein the listing includes at least one phone number for the user to call with respect to at least one of the one or more relevant products or services, wherein the phone number is routed through the call routing system;
wherein the products or services are selected by at least one party independent of the providers of the products or services, and wherein the selection is based at least in part on the quality of the products or services; and
wherein the call routing system receives the phone call.

2. The system according to claim 1 further including a participating call center, communicatively coupled to the call routing system, and further wherein the participating call center is adapted to receive the routed phone call and direct the phone call to an available service agent.

3. The system according to claim 1 further including the ranked order of the relevant products being determined according to one or more criteria.

4. The system according to claim 3 further wherein at least one criterion is the quality of the products or services.

5. A method comprising:
rating at least one product or service based at least in part on the quality of the product or service, wherein the rating is performed by at least one party independent of the providers of the products or services;
listing the at least one product or service on a website based on the rating of the quality of the at least one product and service, and providing at least one phone number on the website for a user visiting the website to call if they are interested in the product or service; and
receiving a phone call to the phone number and routing the phone call, wherein the routing is performed under the control of a party independent of the providers of the products or services.

6. The method according to claim 5 further including a participating call center, and further wherein the participating call center receives the routed phone call and directs the phone call to an available service agent.

7. The method according to claim 5 further including ranking the relevant products or services in the listing, wherein the ranking is determined at least in part at the time the user is viewing the website.

8. The method according to claim 7 further wherein the ranking is determined at least in part based on a fee paid by the provider of a listed product or service.

9. The method according to claim 7 further wherein the ranking is determined in real time at least in part based on a capability of a call center receiving routed phone calls.

10. A system comprising:
a management system, wherein the management system comprises a switch and a computer;
a portal website, communicatively coupled to the management system, the portal website adapted to provide a ranked listing of products or services to a user, wherein the ranking of the listing is performed by:
receiving an indication from the user;
determining one or more relevant products or services using the indication; and
listing the relevant products or services using a ranking, wherein the listing includes a phone number and wherein the listing does not include a hyperlink; and
a participating call center, communicatively coupled to the management system;
wherein the switch is adapted to receive a phone call from the user and route the phone call to a corresponding participating call center, and further wherein the participating call center is adapted to receive the routed phone call and direct the phone call to an available service agent.

11. The system according to claim 10, further comprising scoring the relevant products or services at the computer.

12. The system according to claim 10, wherein the one or more relevant products or services are selected by using criteria selected from the group of product quality indicia, service quality indicia, customer service quality indicia, BBB approval, credit refund policy, or credit cards pre-screening policy.

13. The system according to claim 10, wherein the indication received from the user includes a search term or a menu selection.

14. The system according to claim 10, wherein the ranking uses at least one of a price, an availability of service, an indicia of customer satisfaction, a third-party score, an adjustment value, or a proximity score.

15. A method comprising:
receiving, at a portal website, a user indication;
determining one or more relevant products using the user indication, wherein the one or more relevant products or services are selected by using criteria selected from the group of product quality indicia, service quality indicia, customer service quality indicia, BBB approval, credit refund policy, or credit cards pre-screening policy;
ranking the relevant products; and
presenting the ranked relevant products.

16. The method according to claim 15, wherein the user indication is one of a user search or a user browsing action.

17. The method according to claim 15, wherein the relevant products are ranked using at least one of a price, an availability of service, an indicia of customer satisfaction, a third-party score, or an adjustment value.

18. The method according to claim 15, further comprising:
advertising using one or more mediums to drive traffic to the portal website, wherein the mediums include online advertising, push advertising, radio advertising, television advertising, or print advertising.

19. A method comprising:
receiving one or more search terms;
determining one or more relevant products using the one or more search terms;
ranking the relevant products using at least one of a price, an availability of service, an indicia of customer satisfaction, a third-party score, an adjustment value, or a proximity score; and
presenting the ranked relevant products.

20. The method according to claim 19, wherein presenting the ranked relevant products includes displaying a unique phone number associated with each ranked product.

21. A method comprising:
receiving a user indication, wherein the user indication is one of a user search or a user browsing action;
determining one or more relevant products using the user indication; and
presenting ranked relevant products, wherein the ranking uses one or more factors selected from the group of a price, an availability of service, an indicia of customer satisfaction, a third-party score, an adjustment value, or a proximity score.

22. A system comprising:
a management system, wherein the management system comprises a switch and a computer;
a portal website, communicatively coupled to the management system, the portal website adapted to provide a ranked listing of products or services to a user, wherein the ranking of the listing is performed by:
receiving one or more search terms from the user;
determining one or more relevant products or services, wherein the one or more relevant products or services are selected by using criteria selected from the group of product quality indicia, service quality indicia, customer service quality indicia, BBB approval, credit refund policy, or credit cards pre-screening policy;
scoring the relevant products or services at the computer; and
ordering the scored relevant products or services in one of an ascending order or a descending order; and
a participating call center, communicatively coupled to the management system;
wherein the switch is adapted to receive a phone call from the user and route the phone call to a corresponding participating call center, and further wherein the participating call center is adapted to receive the routed phone call and direct the phone call to an available service agent.

23. A method comprising:
receiving, at a communication switch, a call from a caller, wherein the call is related to one or more advertisements found on a portal website, wherein the portal website provides a ranked listing of the one or more advertisements, and wherein the one or more advertisements are relevant to a search of the portal website performed by the caller;
recording one or more aspects of the incoming communication; and
routing the call to a participating call center, wherein the participating call center is associated with at least one of the one or more relevant advertisements of the user's search.

24. The method according to claim 23, wherein the one or more aspects of the call include a number of calls referred to the participating call center, a phone number of the caller, the time and length of the call, or a recording of the call.
